(19) United States
(12) Patent Application Publication
(10) Pub. No.: US 2003/0160770 A1
(43) Pub. Date: Aug. 28, 2003

(54) Method and apparatus for an adaptive audio-video program recommendation system

(75) Inventor: John Zimmerman, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/084,715

(22) Filed: Feb. 25, 2002

(51) Int. Cl. G09G 5/00

(52) U.S. Cl. 345/204

(57) ABSTRACT

An audio-video program recommendation system stores a list of preferred programs previously selected by a user. Each time the system is activated, the list of previously selected programs is compared with a separate, externally-supplied list of currently available programs, and recommended programs are then displayed in accordance with an algorithm based upon the number and type of previous selections by the user. To avoid repetitive recommendations as well as recommendations erroneously based upon misinterpretation of the user's pattern of selections, a dedicated signal means is provided to allow a user to identify, for storage, programs that the user has selected previously independently of the system. To enhance the system and the stored list or lists, if desired, an additional switch or switches may be provided to identify programs, for example, which the user specifically does not wish to be recommended. Signals derived from the dedicated switches adapt the stored record list or lists to reflect more accurately, the profile of the user's preferences.

### FIELD OF THE INVENTION

This invention relates generally to “recommendation lists” for identifying specific electronic audio-video program materials or other “listed items” that may be of particular interest to a given user, based upon the user's preferences.

### DESCRIPTION OF THE RELATED ART

Individual audio-video programs are readily identifiable and distinguishable from one another by characteristic recorded signals that form part of each program item. Systems are currently available for “recommending” such program items to a particular user in accordance with stored recorded data that identify types of program materials preferred by that user. A serious disadvantage of the known systems of this type, is that they rely on storing patterns of previously made selections, chosen by the user from available program materials. Previously made selections serve a dual purpose in that in a first place, they establish a pattern showing the kind of program material that the user prefers, and in a second place, they allow the elimination from current displays of programs previously chosen for use by the user. However, this form of system operation is a disadvantage because such systems will continuously display programs listings that the user will not ever choose, either because those materials have been viewed previously and will not be viewed again, or because the user otherwise knows the material content and does not find it acceptable for use. Further, a user's failure to choose numerous programs of a given type that the viewer has seen previously outside of the system, may lead the system to “infer”, erroneously, that the user does not prefer those programs and will then stop listing that type of program, entirely, contrary to the user's preference for them. From another standpoint, the “visual clutter” caused by continued listing of programs that the user does not wish to use, is both unacceptable and counter-productive to the intended purpose of the “recommendation” system.

### SUMMARY OF THE INVENTION

The program recommendation system of the present invention avoids the visual clutter, the listing of undesired materials, and the unintended exclusion of otherwise preferred programs that characterize existing recommendation systems. The system of this invention allows users to identify specific programs that the user does and/or does not wish to see listed again. In a preferred form of the invention, the controlling microprocessor of the system is provided with at least one “dedicated” input signaling device, such as a designated push button for example, that creates a unique “add this to the list of previously selected programs” signal to identify a particular program item in all future listings. The system of the invention may be further enhanced, if desired, by providing a similar dedicated push button that associates a unique, “listing preference” signal with specific program items, to be referred to by the microprocessor in the preparation of future recommendation listings.

In the disclosed embodiment of the invention, a conventional television receiver is coupled to a microprocessor programmed to recognize the conventional signals that identify individual programs. An electronic memory device of any suitable type is associated with the microprocessor and coupled to record signals identifying selected programs, so as to create a stored/recorded list of programs that have been selected for viewing. A selectively operable input signal device coupled to the microprocessor permits a user to add a program to the list of previously selected programs [the “previously selected” list] without actually selecting the program for viewing. Preferably, the memory device includes the capacity to maintain separate lists of programs previously selected by different viewers, with each viewer being uniquely identified by separate viewer-identification signals.

When the system is used, a potential viewer enters a signal to access the desired viewer's associated preference list, and then selectively accesses the list of programs currently available. The microprocessor of the recommendation system then compares the preference list with the “currently available” list and processes the two lists according to an algorithm that chooses programs to list as “recommended”, while excluding all programs that are included in the “previously selected” list. In accordance with existing technology, programs are chosen for recommendation based at least in part on the number of times that similarly categorized programs have been selected for viewing by a particular viewer in the past.

By allowing the viewer to add programs, selectively, to the list of previously selected programs, this invention provides users with the advantage of being able to avoid having to deal with repetitive “recommendations” of programs that the viewer has seen previously. Prior art recommendation programs characteristically list all programs of the type “preferred” by a specific viewer, if such programs were not previously selected for viewing through the recommendation system, Following comparison of the lists, the microprocessor of this system forwards the list of “recommended” programs to the video receiver for display,

It is at least feature of the recommendation system of this invention, that a user may modify the list of previously viewed programs by adding to it, selectively, programs that were not previously selected through the system.

These and other features and advantages of this invention will be made more apparent to those having skill in this art, by reference to the following detailed description of the preferred embodiment considered in conjunction with the accompanying drawings.

### BRIEF DESCRIPTION OF THE DRAWINGS

FIG. 1 is a simplified, overall block diagram of the recommendation system of this invention;

FIG. 2 is a flow chart illustrating the sequential steps in the operation of the disclosed system of this invention; and,

FIG. 3 represents an illustrative “menu” of the type that the system of this invention presents to a user.

### DETAILED DESCRIPTION OF THE PREFERRED EMBODIMENT

In the following description, certain specific details of the disclosed embodiment such as architecture, interfaces and techniques, etc, are set forth for purposes of explanation rather than limitation, so as to provide a clear and thorough understanding of the present invention. However, it should be understood readily by those skilled in this art, that the present invention may be practiced in other embodiments which do not conform exactly to the details set forth herein, without departing significantly from the spirit and scope of this disclosure. Further, in this context, and for the proposes of brevity and clarity, detailed descriptions of well-known apparatus, circuits and methodology have been omitted so as to avoid unnecessary detail and possible confusion.

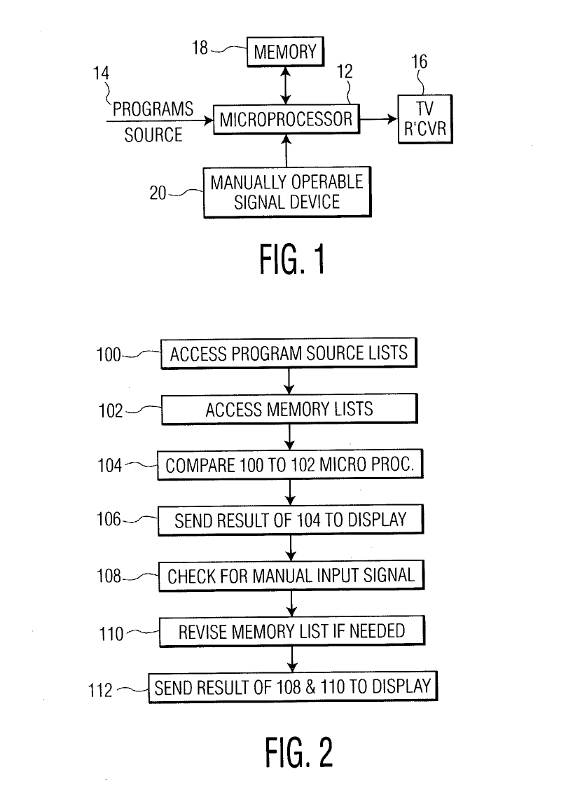

Referring now to FIG. 1 of the accompanying drawings, the disclosed program recommendation system 10 in accordance with this invention may be seen to comprise a microprocessor 12 coupled to receive program listings from a program source 14 and to display programs as well as processed results on a conventional TV receiver 16. The microprocessor is further coupled to exchange information with an electronic memory device 18 and to receive viewer preference signals from a selectively operable input signal device 20. In this regard, it should be noted that microprocessor 12 and memory device 18 may be embodied in the form of a conventional computer apparatus, and selectively operable signal device 20 accordingly may be, for example, merely a conventional computer keyboard with one or more “dedicated” keys or “push buttons” assigned to perform the tasks herein disclosed.

In use, receiver 16 is coupled to program source 14 to receive program signals through microprocessor apparatus 12, in a substantially conventional manner. A user wishing to obtain a recommendation of program materials in accordance with this invention would tune receiver 16 to a reception channel showing listings of available program materials. Such “program guide channels” are well-known and widely available from many sources; they are known to include category and content signals that characterize various types of programs for use by viewers seeking assistance in choosing programs for viewing.

When microprocessor 12 is activated, it delivers electronic “recommender menu” signals to receiver 16 to facilitate utilization of the recommender system by a user. Electronic menu signals of either passive or interactive type are well-known in the art at this time, and the apparatus and methods for their generation will not be explained in further detail here. In this regard, the term, “passive”, refers to menus which merely instruct the user to take a certain action, but the menu plays no other part in effectuating the suggested action or instruction; on the other hand, the term, “interactive”, is used here in reference to menus of the touch-screen type, in which the user “interacts” with the menu by touching part of the display screen and the menu in turn “interacts” with the user's touch by effectuating the instruction or advice corresponding to the location that has been touched.

For the purposes of this invention, the menu displays on the screen of receiver 16, instructions for the user to follow so as to initiate action of the recommendation system. Accordingly, one instruction would request identification of the user, for example by pressing one of a predetermined number of “user buttons” on the selectively operable input signal device 20. Microprocessor 12 responds to the user identification signal received from signal device 20 by accessing a “user preference profile” stored in electronic memory device 18. The creation, storage and accessing of such profiles are likewise well-known at this time and, accordingly, will not be explained further for the purposes of this disclosure.

After the applicable user profile for the identified user has been accessed, it is compared by the microprocessor 12 with the list of available programs obtained from program source 14, and a resulting list of “recommended” programs is then delivered to the display screen (not shown) of receiver 16 in accordance with any suitable well-known technique. Microprocessor 12 accompanies the display of recommended programs with a suitable added “menu” that allows the user the option of marking or otherwise identifying a “selected” program item on the recommended list.

In addition to the selection option, the user is presented with at least two additional options concerning the selected program item: one option allows the user to proceed with viewing of the selected item (i.e. the “View” option). In accordance with this invention, a second option of significant importance allows the user to mark the selected item with an identifying signal indicating that the viewer has seen the selected program item previously and does not wish to have it “recommended” again. Both of these options are activated in the disclosed embodiment by “dedicated” push buttons associated with selectively operable input signal device 20. However, it will be understood readily by those skilled in this art, that activation techniques other than dedicated push buttons may be used within the scope and spirit of this disclosure. For example, as explained briefly in a preceding paragraph in this specification, interactive touch-screen menus may be used, in which an option is effectuated when the user merely touches an appropriate, indicated location on the video screen of receiver 16.

To more clearly disclose and point out the operation of the system of this invention, FIG. 2 of the drawings presents a flow chart of system steps that follow activation of both microprocessor 12 and receiver 16 of FIG. 1. Accordingly, FIG. 2 shows that the first step 100 in the operation of the system is the accessing of a list of available program materials, obtained from program source 14 such as, for example, commercial cable or broadcast signals. This “step” is achieved by a user manually selecting a corresponding broadcast or cable channel, using the channel-tuning capability of receiver 16 of FIG. 1.

In step 102, subsequent to step 100, in response to a viewer request to activate the recommender system, microprocessor 12 accesses the appropriate user profile stored in memory device 18 and then proceeds with a comparison, step 104; comparing the user “profile” with the “available” list to produce a short, “recommended” list of recommended program items. In effect, step 104 applies a recommendation algorithm to select from the list of available program items a predetermined number of recommended items, say 3 or 5 or 10 or any other reasonable number, based upon identification of the category and frequency of related selections previously made or viewed by the user.

In step 106, microprocessor 12 directs the “recommended” list to display on the screen of receiver 16 together with an action “menu”, for inspection and further action by the user. In accordance with this invention the viewer then has to choose among various menu options so that the system can continue its operations. That is, the viewer first has the option of “selecting” one of the program items that appears on the “recommended” list. As in many video display systems, a listed item is “selected” by moving a cursor or marker onto the listed item on the screen and then activating an “enter” or “selection” button. In the system here disclosed, such an activation button is provided conveniently on any convenient surface of the selectively operable input signal device 20. After an item has been selected in this or any readily equivalent manner, the user of the system of this invention next has the options, as explained in further detail below, of either electing to “view” the selected item or, identifying the selected item as having been “previously seen”. In this context, “previously seen” means generally that the user has previously viewed the selected program item outside the purview of this system.

In step 108, microprocessor 12 checks for receipt of the “selection” and “previously seen” or “view” signals from selectively operable electronic input signal device 20. If “view” is detected together with the “select” signal, step 110, microprocessor 12 then couples receiver 16 to display the selected program and disengages from further “recommendation” action until it is called upon to initiate a further recommendation sequence. In the alternative, if “previously seen” is detected together with the selection “signal”, step 112, microprocessor 12 acts to (a) revise the display on receiver 12 to show a revised list of recommended program items, and (b) revise the viewer profile stored in memory device 18 so as to associate the “previously seen” signal with the “selected program” for all future comparison actions. Accordingly, that specific program item will be treated in the future in substantially the same manner as though the user had selected the program for viewing. In fact, it should be recognized that the principal distinction between the “select” signal and the “previously seen” signal for the purpose of this invention is that the system must not select the previously seen program for viewing in response to the “previously seen” signal generated by selectively operable electronic input signal device 20.

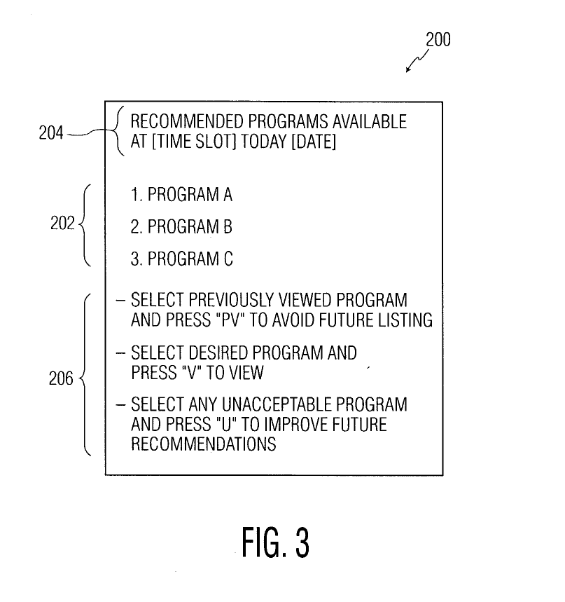

To further point out and clarify operation of the system of this invention, FIG. 3 illustrates an embodiment of a typical “screen menu” 200 that would be displayed for a user of the system after completion of steps 100 through 106. In brief, microprocessor 12 causes the “menu” items to appear on the screen of receiver 12 in association with the program items that the microprocessor has chosen to “recommend.” Accordingly, a predetermined number (three are shown for purposes of illustration only), of program recommendations 202 appear on the screen together with an illustrative/explanatory caption 204, such as “Recommended Programs Available at (next available start time or another selected time within the range of the commercially supplied list of all ‘available’ programs) Today”, the whole being accompanied by instructional material 206 presenting the specific options described previously herein, for example: [1] “Highlight any previously viewed program(s) and press PV to avoid repeat listing of this program”; and [2] Highlight any program selected for viewing and press V to view”.

Although a most significant menu option provided by the recommendation system of this invention has been disclosed and described, those having skill in this art will recognize that a wide variety of additional “options” may be provided on the same or separate viewing screens, if desired. For example, under some circumstances, it would be desirable to include and list as an option: Highlight unacceptable program and press U to help identify and avoid listing of similar category programs in the future. It should be understood that such an option could speed up and generally enhance the process of building a profile of the user's preferences. In this application, the term “recommendation lists” is intended to include movies, music, books, and other items in which a recommender system can learn by observing the user's selection over time to generate a user profile. For example, a user profile on a particular user's reading and purchasing habits over the Internet may be used as criteria to void undesirable in all future listings.

Although a preferred embodiment of the invention has been illustrated and described, it will be obvious to those having skill in this art that various other forms and embodiments now may be visualized readily without departing significantly from the spirit and scope of the invention disclosed herein and set forth in the accompanying claims.

What is claimed is:

1. An audio-video program recommendation system for listing program material in accordance with a user's preferences, said system comprising:
a microprocessor for recognizing and processing identifying signals for program items;
an electronic storage device coupled to said microprocessor for storing look-up lists of program items and signals associated therewith;
a recommendation algorithm incorporated into said microprocessor for choosing and listing recommended program items based upon the nature and frequency of previous program item selections that are recorded in said look-up lists in said electronic memory device; and,
a user-operable input signal device coupled to said microprocessor, enabling a user to selectively identify selected ones of said recommended program items as having been previously viewed, such that said microprocessor then adds said selected ones of said program items to said look-up lists in said memory device.

2. An audio-video program recommendation system in accordance with claim 1, wherein said user operable input device is a dedicated push-button.

3. An audio-video program recommendation system in accordance with claim 1, wherein said user operable input device comprises a plurality of dedicated push buttons, at least one of said plurality of push buttons serving to selectively identify said selected ones of said recommended program items as having been previously viewed, and at least another one of said push buttons serving to identify a selected one of said recommended program items for current viewing.

4. An audio-video program recommendation system in accordance with claim 3, wherein said recommendation algorithm further serves to recognize program items that are identified as unacceptable; said microprocessor is programmed to create a look-up list of unacceptable programs for storage in said memory device; and, at least another one of said plurality of dedicated push buttons serves to identify unacceptable programs for storage in said memory device.

5. An audio-video program recommendation system for listing program material in accordance with a user's preferences, said system comprising:
a computer apparatus capable of recognizing, processing and storing look-up lists of identifying signals for program items;
a recommendation algorithm incorporated into said computer apparatus for choosing and listing recommended program items based upon the nature and frequency of previous program item selections that are recorded in said look-up lists; and,
said computer apparatus further comprises a keyboard having at least one key capable of identifying selected ones of said recommended program items as having been previously viewed, such that said computer apparatus then adds said selected ones of said program items to said look-up lists.

6. An audio-video program recommendation system in accordance with claim 5, wherein said user operable input device is a dedicated push-button on a computer keyboard.

7. An improved method of recommending program listings in accordance with a user's selection preferences, said method comprising the steps of:
accessing a first electronic list representing programs available for viewing at a given time;
accessing a second electronic list representing a compilation of programs previously selected for viewing by an identified user of the system;
comparing said first electronic list with said second electronic list, to obtain a list of recommended program items based upon the nature of the previously selected programs identified in said second electronic list;
displaying said list of recommended program items on a video display device for inspection by said user;
selectively identifying and characterizing by a corresponding electronic signal, a program item on said list of recommended program items that was previously viewed by said user;
appending to aid second electronic list, program items included in said list of recommended program items that are currently selectively identified and characterized by said identified user; and,
displaying said first electronic list on a video display device, while excluding from said display all programs on said second list.

8. An proved method of recommending program listings in accordance with claim 7, further comprising the step of checking for the receipt of a signal indicating the user's desire to view a program and presenting such identified program item for viewing.

9. An improved method of recommending program listings in accordance with claim 7, further comprising he step of displaying a screen menu, together with said displaying of recommended program items, indicating the actions to be taken by a user employing said method.

10. An improved method of recommending program listings in accordance with claim 9, further comprising the step of displaying together with said screen menu, an illustrative caption identifying said method of recommending program listings.
